(19) United States
(12) Patent Application Publication
(10) Pub. No.: US 2025/0330030 A1
(43) Pub. Date: Oct. 23, 2025

(54) ELECTRICITY STORAGE APPARATUS AND METHOD OF INTERRUPTING ELECTRIC CURRENT

(71) Applicant: Prime Planet Energy & Solutions, Inc., Tokyo (JP)

(72) Inventor: Junya YANO, Kato-shi (JP)

(21) Appl. No.: 19/098,991

(22) Filed: Apr. 3, 2025

(30) Foreign Application Priority Data
Apr. 17, 2024 (JP) 2024-066785

(51) Int. Cl. H02J 7/00; H01M 50/583

(52) U.S. Cl. CPC H02J 7/0031; H01M 50/583; H02J 7/00304; H02J 7/00308; H02J 7/0047

(57) ABSTRACT

An electricity storage apparatus includes an electricity storage device module, a voltage sensor, a pyro-fuse, and a controller. The voltage sensor detects a voltage value of the electricity storage device module. The current sensor detects a current value flowing in the electricity storage device module. The pyro-fuse is connected in series to the electricity storage device module. The controller sets a voltage condition and a current condition. The voltage condition is predetermined based on the voltage value detected by the voltage sensor. The current condition is predetermined based on the current value detected by the current sensor. The controller causes the pyro-fuse to activate when both the voltage condition and the current condition are satisfied.

### CROSS REFERENCE TO RELATED APPLICATIONS

The present application claims priority from Japanese Patent Application No. 2024-066785 filed on Apr. 17, 2024, which is incorporated by reference herein in its entirety.

### BACKGROUND

The present disclosure relates to an electricity storage apparatus and a method of interrupting electric current.

JP 2022-133241 A discloses a contactor for selectively connecting and disconnecting a battery. The contactor disclosed in the publication includes a sub-circuit, a magnetic sensor, and a controller. The sub-circuit includes an electrical conductor portion, a switch, and a fuse that are connected in series. The magnetic sensor measures electric current flowing through the electrical conductor portion. The contactor further includes a detection means for detecting if the switch is actually open or closed. The controller detects whether or not an overcurrent condition occurs. The controller causes the switch to open if the overcurrent condition is detected. The controller detects whether or not a primary switch is actually open. The controller causes the fuse to blow out if it is detected that the switch is still closed.

### SUMMARY

The present inventor intends to further improve the safety of electricity storage apparatuses.

According to the present disclosure, an electricity storage apparatus includes an electricity storage device module, a voltage sensor, a pyro-fuse, and a controller. The electricity storage device module includes a plurality of electricity storage devices. The voltage sensor detects a voltage value of the electricity storage device module. The current sensor detects a current value flowing in the electricity storage device module. The pyro-fuse is connected in series to the electricity storage device module. The controller causes the pyro-fuse to activate. The controller sets a voltage condition and a current condition. The voltage condition is predetermined based on the voltage value detected by the voltage sensor. The current condition is predetermined based on the current value detected by the current sensor. The controller causes the pyro-fuse to activate when both the voltage condition and the current condition are satisfied. Such an electricity storage apparatus provides improved safety.

### BRIEF DESCRIPTION OF THE DRAWINGS

FIG. 1 is a schematic view illustrating an electricity storage apparatus 100.

FIG. 2 is a flowchart illustrating processes executed by a controller 50.

FIG. 3 is a timing chart illustrating the control for activating a pyro-fuse 40 effected by the controller 50.

### DETAILED DESCRIPTION

Hereinbelow, embodiments of the technology according to the present disclosure will be described with reference to the drawings. It should be noted, however, that the disclosed embodiments are, of course, not intended to limit the disclosure. The drawings are depicted schematically and do not necessarily accurately depict actual objects. The features and components that exhibit the same effects are designated by the same reference symbols as appropriate, and the description thereof will not be repeated as appropriate.

### Electricity Storage Apparatus 100

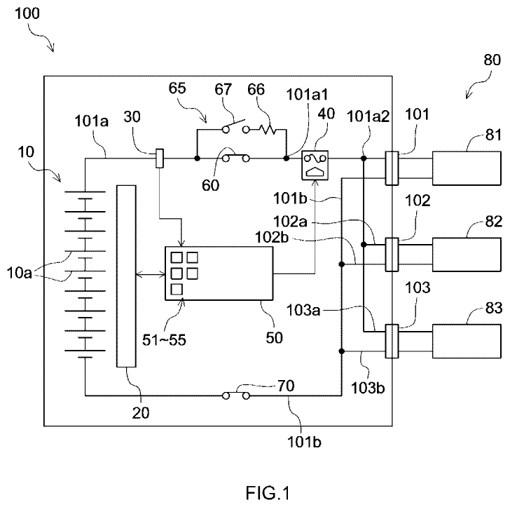

FIG. 1 is a schematic view illustrating an electricity storage apparatus 100. As illustrated in FIG. 1, the electricity storage apparatus 100 includes an electricity storage device module 10, a voltage sensor 20, a current sensor 30, a pyro-fuse 40, and a controller 50. The electricity storage apparatus 100 may also be referred to as an electricity storage device pack, which is an assembled component including, in addition to electricity storage devices, a configuration for controlling the electricity storage devices.

### Electricity Storage Device Module 10

The electricity storage device module 10 includes a plurality of electricity storage devices 10a. The electricity storage device module 10 includes a positive electrode and a negative electrode. The electricity storage devices 10a are configured to be able to provide electric energy therefrom. The electricity storage devices 10a store electric power supplied from a charger 83. The electricity storage devices 10a are connected to a load 81 via a connector 101. The electricity storage devices 10a supply electric power to the load 81.

The electricity storage devices 10a may include a secondary battery in which repeated charging and discharging are possible by means of migration of charge carriers through an electrolyte between a pair of electrodes (positive electrode and negative electrode). The electricity storage devices 10a may include a lithium-ion secondary battery, a nickel-metal hydride battery, or the like, for example. In the electricity storage device module 10, the electricity storage devices 10a may be connected in series, connected in parallel, or connected in a combination of series and parallel connections. This embodiment employs the electricity storage device module 10 in which a plurality of electricity storage devices 10a are connected in series. It is possible that there may be one or a plurality of electricity storage device modules 10.

The electricity storage apparatus 100 is provided with connectors 101 to 103. The connector 101 is connected to a connecting wire 101a extending from the positive electrode of the electricity storage device module 10 and a connecting wire 101b extending from the negative electrode of the electricity storage device module 10. The connecting wire 101a is connected to a connecting wire 102a extending from the connector 102 and a connecting wire 103a extending from the connector 103. The connecting wire 102a is branched from the connecting wire 101a. The connecting wire 103a is branched from the connecting wire 102a. The connecting wire 101b is connected to a connecting wire 102b extending from the connector 102 and a connecting wire 103b extending from the connector 103. The connecting wires 102b and 103b are branched from the connecting wire 101b. The connectors 101 to 103 are configured to be connectable with an external connected device 80. The electricity storage apparatus 100 may be connected to the connected device 80 via at least one connector of the connectors 101 to 103.

The connected device 80 may include, but is not particularly limited to, a load 81, a DC/DC converter 82, and a charger 83, for example. In this embodiment, the electricity storage apparatus 100 is connected to the load 81 via the connector 101. The load 81 is supplied with electric power from the electricity storage device module 10 of the electricity storage apparatus 100. In this embodiment, the load 81 is a load in an electrically powered vehicle, which may include an electric motor, an inverter, or the like of the vehicle. The electricity storage apparatus 100 is not limited to such an embodiment but may be applicable to electricity storage apparatuses other than those incorporated in electrically powered vehicles. The charger 83 is a device that is able to supply electric power to the electricity storage device module 10. The charger 83 may be one that charges the electricity storage device module 10 by rapid charging or one that charges the electricity storage device module 10 by normal charging.

A first contactor 60 and a second contactor 70 are disposed between the electricity storage device module 10 and the connectors 101 to 103. Connection and disconnection between the electricity storage device module 10 and the connected device 80 are switched by the first contactor 60 and the second contactor 70. The first contactor 60 is provided on the connecting wire 101a, which extends from the positive electrode of the electricity storage device module 10 toward the connectors 101 to 103. In other words, the first contactor 60 is provided between the positive electrode of the electricity storage device module 10 and the connectors 101 to 103. The second contactor 70 is provided on the connecting wire 101b, which extends from the negative electrode of the electricity storage device module 10 to the connectors 101 to 103. In other words, the second contactor 70 is provided between the negative electrode of the electricity storage device module 10 and the connectors 101 to 103.

The first contactor 60 and the second contactor 70 are each configured to be individually switchable between a closed state and an open state. The first contactor 60 and the second contactor 70 may be, but are not particularly limited to, electromechanical relays, semiconductor relays, and the like. In the electricity storage apparatus 100, the electricity storage device module 10 and the external connected device 80 are electrically connected to each other when both the first contactor 60 and the second contactor 70 are in the closed state. Switching between the open state and the closed state of the first contactor 60 and the second contactor 70 may be controlled by the controller 50.

The electricity storage apparatus 100 is provided with a pre-charge circuit 65 that prevents inrush current from flowing into the connected device 80 and the electricity storage device module 10. The pre-charge circuit 65 is connected in parallel to the first contactor 60. The pre-charge circuit 65 is a circuit including a pre-charge resistor 66 and a pre-charge relay 67 that are connected in series. The pre-charge circuit 65 prevents inrush current from flowing, for example, when electric power is supplied from the electricity storage apparatus 100 to the load 81, when electric power is supplied from the charger 83 to the electricity storage apparatus 100, and the like. In the following, controlling of opening and closing of the first contactor 60, the second contactor 70, and the pre-charge relay 67 is described using the start-up of the load 81 as an example.

For example, before starting up the load 81, the first contactor 60, the second contactor 70, and the pre-charge relay 67 are in the open state. When starting up the load 81, the second contactor 70 and the pre-charge relay 67 are switched to the closed state. This allows the load 81 to be connected to the electricity storage device module 10 via the pre-charge circuit 65. At this time, because the pre-charge circuit 65 is provided with the pre-charge resistor 66, the load 81 is supplied with electric power from the electricity storage device module 10 at a low current. Thereafter, the first contactor 60 is brought into the closed state while the potential of the load 81 is kept high. Subsequently, the pre-charge relay 67 is brought into the open state. This prevents a high current from flowing when the load 81 is started up.

The voltage value and the current value of the electricity storage device module 10 are detected respectively by the voltage sensor 20 and the current sensor 30. The electricity storage apparatus 100 is provided with the pyro-fuse 40 that is activated based on the voltage value and the current value of the electricity storage device module 10.

### Voltage Sensor 20

The voltage sensor 20 detects the voltage value of the electricity storage device module 10. The voltage sensor 20 may be able to measure the voltage of the electricity storage device module 10, or may be able to measure each of the voltages of one or a plurality of the electricity storage devices 10a that constitute the electricity storage device module 10. In this embodiment, the voltage sensor 20 is configured to measure each of the voltages of the electricity storage devices 10a that are connected in series. The voltage sensor 20 is configured to be communicable with the controller 50. The voltage of the electricity storage device module 10 that is measured by the voltage sensor 20 is transmitted to the controller 50.

### Current Sensor 30

The current sensor 30 measures a charging/discharging current flowing in the electricity storage device module 10. In this embodiment, the current sensor 30 is provided between the electricity storage device module 10 and the first contactor 60. The location of the current sensor 30 is not particularly limited. The current sensor 30 is configured to be communicable with the controller 50. The charging/discharging current measured by the current sensor 30 is transmitted to the controller 50.

### Pyro-Fuse 40

The pyro-fuse 40 is connected in series to the electricity storage device module 10. The pyro-fuse 40 is a safety device provided in the electricity storage apparatus 100. The pyro-fuse 40 is a gunpowder-based current interrupting device. The pyro-fuse 40 contains gunpowder to interrupt the conductive path by detonating the gunpowder. The pyro-fuse 40 is provided on the conductive path connecting the electricity storage device module 10 to the connected device 80. The pyro-fuse 40 is provided between a positive electrode-side connection point 101a1, which connects the first contactor 60 and the pre-charge circuit 65, and a connection point 101a2, from which the connecting wire 102a is branched.

The location at which the pyro-fuse 40 is to be provided is not limited to any particular location as long as it is able to interrupt the conductive path of the electricity storage device module 10. It is also possible that the pyro-fuse 40 may be provided between the electricity storage device module 10 and the first contactor 60. The pyro-fuse 40 may be provided on the connecting wire 101b, which extends from the negative electrode of the electricity storage device module 10 to the connectors 101 to 103. When a plurality of electricity storage device modules 10 are connected in series, the pyro-fuse 40 may be provided between adjacent electricity storage device modules 10. The pyro-fuse 40 is activated by the controller 50.

### Controller 50

The controller 50 causes the pyro-fuse 40 to activate according to a predetermined condition. The controller 50 may be a computer, such as an ECU (electronic control unit) or a circuit board with a built-in microcomputer, for example. The computer performs required functions according to, for example, a predetermined program. Various functions of the computer may be processed by cooperation of software with an arithmetic unit [also referred to as a processor, CPU (central processing unit), or MPU (micro-processing unit)] and a memory storage device (such as a memory and a hard disk) of the computer.

The controller 50 includes a communicator 51, a voltage condition setter 52, a current condition setter 53, a determinator 54, and an instructor 55. The various units 51 to 55 of the controller 50 may be implemented by a single processor or a plurality of processors, or may be incorporated in a circuit. The communicator 51 of the controller 50 is configured to be communicable with the voltage sensor 20 and the current sensor 30.

Communication of the controller 50 with the voltage sensor 20 and the current sensor 30 may be achieved by signal transmission and reception. The form of communication of the controller 50 with the voltage sensor 20 and the current sensor 30 is not limited to any particular form. For example, the controller 50 may receive the information transmitted from the voltage sensor 20 and the current sensor 30 (voltage value information and current value information) in the form of a digital signal, an analog signal, a logic signal, a PWM (Pulse Width Modulation) signal, or a wireless signal. The controller 50 may receive the voltage value information and the current value information in different types of signals. The controller 50 may receive the voltage value information as a digital signal and the current value information as an analog signal, for example. The controller 50 may receive the voltage value information and the current value information in the same type of signal. The controller 50 may receive the voltage value information and the current value information as digital signals, for example.

When the electricity storage apparatus 100 is connected to the connected device 80 and the electricity storage apparatus 100 is started up, the opening and closing of the first contactor 60, the second contactor 70, and the pre-charge relay 67 are controlled in the above-described sequence. The electricity storage apparatus 100 is connected to the connected device 80, and charging and discharging of the electricity storage apparatus 100 are started. During charging and discharging of the electricity storage apparatus 100, the controller 50 acquires the voltage value V detected by the voltage sensor 20 and the current value I detected by the current sensor 30.

The controller 60 sets a voltage condition that is predetermined based on a voltage value and a current condition that is predetermined based on a current value. The voltage condition is set by the voltage condition setter 52. The current condition is set by the current condition setter 53. The controller 50 causes the pyro-fuse 40 to activate when both the voltage condition and the current condition are satisfied. The voltage condition and the current condition may each include one or more conditions. The voltage condition setter 52 may set one or a plurality of voltage conditions. The current condition setter 53 may set one or a plurality of voltage conditions. For the voltage condition and the current condition, different conditions may be set during discharging (such as when electric power is supplied from the electricity storage device module 10 to the load 81) and charging (such as when the electricity storage device module 10 is charged from the charger 83).

The following describes an example of the processes executed by the controller 50 during charging and discharging of the electricity storage apparatus 100.

In this embodiment, the voltage condition during discharging is set to be that “the voltage value V of the electricity storage device module 10 is less than or equal to a predetermined threshold value Vth (lower limit threshold value Vthl)”. Also, the current condition is set to be that “the current value I of the electricity storage device module 10 is higher than or equal to a predetermined threshold value Ith”. Herein, the threshold value Ith is set to be a positive value, and the absolute value of the current value I is compared with the threshold value Ith. The determinator 54 determines whether or not the voltage value V and the absolute value of the current value I respectively satisfy the conditions determined based on the threshold values Ith and Vth. Thus, the current condition may be determined by comparing the absolute value of the measured value of the current value I with the threshold value Ith, and the voltage condition may be determined by comparing the measured value of the voltage value V with the threshold value Vth.

In addition, the voltage condition during charging is set to be that “the voltage value V of the electricity storage device module 10 is higher than or equal to a predetermined threshold value Vth (upper limit threshold value Vthu)”.

Although the current flows in different directions during discharging and during charging, the threshold value Ith may be the same value both during discharging and during charging. For this reason, unlike the voltage condition, the current condition may be set to be the same condition both during discharging and during charging. It should be noted that such an embodiment is merely illustrative, and the current condition may be set based on the measured value of the current value I. For example, during discharging (when the current is a positive value), the current condition may be set to be that “the current value I is higher than or equal to a predetermined upper limit threshold value Ithu”, whereas during charging (when the current is a negative value), the current condition may be set to be that “the current value I is lower than or equal to a predetermined lower limit threshold value Ithl”. It is also possible that, irrespective of during discharging or charging, the current condition may be set to be that “the current value I is higher than or equal to the predetermined upper limit threshold value Ithu or the current value I is lower than or equal to the predetermined lower limit threshold value Ithl”.

Note that in this embodiment, the voltage sensor 20 is configured to measure each of the respective voltage values of the plurality of electricity storage device 10a. From the voltage sensor 20 to the controller 50, the respective voltage values V of the plurality of electricity storage devices 10a are transmitted. The controller 50 sets the voltage condition based on the voltage of one of the plurality of electricity storage devices 10a. Herein, the determinator 54 determines whether or not one of the plurality of electricity storage devices 10a satisfies the voltage condition (whether or not the voltage value of each of the electricity storage devices 10a is lower than or equal to the threshold value Vth). The voltage values V of the plurality of electricity storage devices 10a may be different from one another. When at least one of the plurality of electricity storage devices 10a satisfies the voltage condition, the determinator 54 determines that the voltage value V satisfies the voltage condition. Note that the determination of the voltage condition is not limited to the determination that is made based on the voltage value V of one electricity storage device 10a. For example, when a plurality of electricity storage device modules 10 are provided, the determination may be made based on the voltage value V of one of the plurality of electricity storage device modules 10. Alternatively, the voltage condition may be determined based on the voltage value V of all the plurality of electricity storage device modules 10 (i.e., the total voltage).

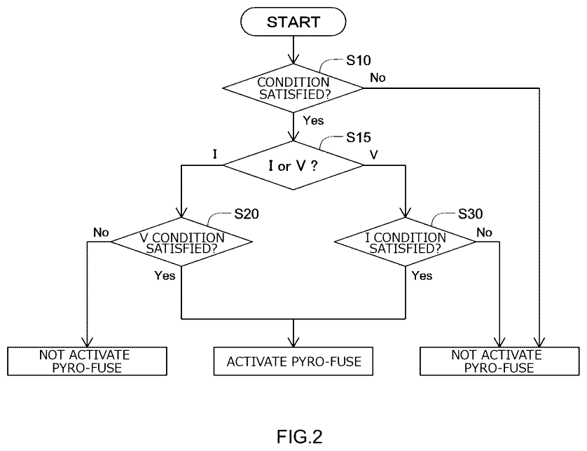

FIG. 2 is a flowchart illustrating processes executed by the controller 50. When the electricity storage apparatus 100 starts charging and discharging and the controller 50 acquires a voltage value from the voltage sensor 20 and a current value from the current sensor 30, the controller 50 starts controlling whether or not to activate the pyro-fuse 40.

At step S10 (see FIG. 2), the determinator 54 determines whether or not the voltage value V and the current value I respectively satisfy the determination conditions (the voltage condition and the current condition). If neither the voltage value V nor the current value I respectively satisfies the voltage condition or the current condition (No), the pyro-fuse 40 is not activated, and charging and discharging from the electricity storage device module 10 is continued. If either one of the voltage value V and the current value I satisfies the condition (Yes), the process proceeds to step S15 (see FIG. 2).

At step S15, it is determined which one of the voltage value V and the current value I satisfies the condition. At step S15, if the current value I is higher than or equal to the threshold value Ith, so the current condition is satisfied, the process proceeds to step S20 (see FIG. 2). At step S20, it is determined whether or not the voltage value V satisfies the voltage condition. If the voltage value V is higher than the threshold value Vth, so the voltage condition is not satisfied (No), the pyro-fuse 40 is not activated, continuing the charging and discharging from the electricity storage device module 10. If the voltage value V is lower than or equal to the threshold value Vth, so the voltage condition is satisfied (Yes), the controller 50 transmits a shut-down signal from the instructor 55 to the pyro-fuse 40. The pyro-fuse 40 is activated by the received shut-down signal, to rapture the conductive path (the connecting wire 101a in this embodiment).

On the other hand, at step S15, if the voltage value Vis lower than or equal to the threshold value Vth, so the voltage condition is satisfied, the process proceeds to step S30 (see FIG. 2). At step S30, it is determined whether or not the current value I satisfies the current condition. If the current value I is lower than the threshold value Ith, so the current condition is not satisfied (No), the pyro-fuse 40 is not activated, continuing the charging and discharging from the electricity storage device module 10. If the current value I is higher than or equal to the threshold value Ith, so the current condition is satisfied (Yes), the controller 50 transmits a shut-down signal from the instructor 55 to the pyro-fuse 40. The pyro-fuse 40 is activated by the received shut-down signal, to rapture the conductive path (the connecting wire 101a in this embodiment).

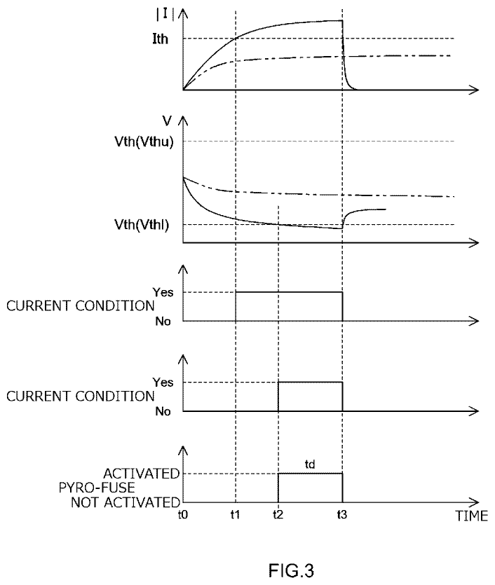

FIG. 3 is a timing chart illustrating the control for activating the pyro-fuse 40 effected by the controller 50. FIG. 3 shows a control operation that is executed based on variations of the voltage value V and the current value I when electric power is supplied from the electricity storage apparatus 100 to the load 81 (i.e., when the electricity storage apparatus 100 is discharged). The threshold value Ith is a set value of electric current at which it is considered that an overcurrent flows. The threshold value Ith may be set to a numerical value that is higher than (or higher than or equal to) a value of current that may flow when the electricity storage device module 10 is normally used. The threshold value Vth is a set value of voltage at which it is considered that an overdischarge occurs. The threshold value Vth may be set at values within the range in which it may take during normal use of the electricity storage device module 10. For the threshold value Vth, it is possible to set a lower limit threshold value Vthl and a upper limit threshold value Vthu. The lower limit threshold value Vthl and the upper limit threshold value Vthu may be set according to the rated voltage, maximum charge voltage, and the like of the electricity storage devices 10a.

In FIG. 3, variations of the current value I and the voltage value V when the pyro-fuse 40 is activated, such as when a failure occurs in the electricity storage devices 10a, are indicated by solid lines, whereas variations of the current value I and the voltage value V when the pyro-fuse 40 is not activated are indicated by dash-dot-dot lines. It should be noted that FIG. 3 merely shows an example of variations of the voltage value V and the current value I, and the voltage value V and the current value I do not necessarily vary in the manner as shown in FIG. 3.

First, a description is made regarding the process in which the controller 50 causes the pyro-fuse 40 to activate when a failure occurs in the electricity storage devices 10a (that is, the embodiment indicated by solid lines in FIG. 3).

After the start of discharging (time t0), the determination process of step S10 of FIG. 2 is started. Electric current flows to supply electric power stored in the electricity storage device module 10 to the load 81. The current value I gradually rises, and the voltage value V starts to fall. Neither of the conditions of current value I and voltage value V (the current condition and the voltage condition) is satisfied (determination is “No” in step S10), so the pyro-fuse 40 is not activated.

In this embodiment, the current value I reaches the threshold value Ith at the time point of time t1. After time t1, it is determined as “Yes” in step S10. Herein, it is determined that the “current condition” is satisfied in step S15. The voltage value V is higher than the threshold value Vth (higher than the lower limit threshold value Vthl and lower than the upper limit threshold value Vthu), it is determined as “No” in step S20, and the pyro-fuse 40 is not activated.

At the time point of time t2, the current value I remains higher than or equal to threshold value Ith. At the time point of time t2, the voltage value V is further lower, reaching the threshold value Vth (the lower limit threshold value Vthl in this embodiment). After time t2, it is determined as “Yes” in step S20, so the pyro-fuse 40 is activated.

In this embodiment, there is delay time td from the time when it is determined as “Yes” in step S20 to the time when the controller 50 causes the pyro-fuse 40 to activate. For this reason, the pyro-fuse 40 is activated at the time point of time t3, at which the delay time td has elapsed from time t2 at which it is determined as “Yes” in step S20.

Next, a description is made regarding the process in which the electricity storage device module 10 operates normally and the controller 50 does not cause the pyro-fuse 40 to activate (that is, the embodiment indicated by dash-dot-dot lines in FIG. 3).

As shown by dash-dot-dot lines in FIG. 3, when there is no failure in the electricity storage device module 10, the current value I remains lower than the threshold value Ith and the voltage value V remains higher than the lower limit threshold value Vthl (the voltage value V remains higher than the lower limit threshold value Vthl and lower than the upper limit threshold value Vthu). In this case, it is determined as “No” in step S10, so the pyro-fuse 40 is not activated.

Note that the controller 50 may detect noise of the signals transmitted from the voltage sensor 20 and the current sensor 30 (i.e., the voltage value V and the current value I). Due to the signal noise, it may be determined that either one of the voltage value V and the current value I satisfies the condition temporarily. At this time, it is determined as “Yes” in step S10. If it is determined at step S15 that the current value I is higher than or equal to the threshold value Ith due to the noise, the process proceeds to step S20. Because the voltage value V is higher than the lower limit threshold value Vthl and lower than the lower limit threshold value Vthl, it is determined as “No” in step S20, and the pyro-fuse 40 is not activated. If it is determined at step S15 that the voltage value V is higher than or equal to the lower limit threshold value Vthl due to the noise (or higher than or equal to the upper limit threshold value Vthu), the process proceeds to step S30. Because the current value I is lower than the threshold value Ith, it is determined as “No” in step S30, and the pyro-fuse 40 is not activated.

In the above-described embodiment, the electricity storage apparatus 100 includes an electricity storage device module 10, a voltage sensor 20, a current sensor 30, a pyro-fuse 40, and a controller 50. The electricity storage device module 10 includes a plurality of electricity storage devices 10a. The voltage sensor 20 detects a voltage value V of the electricity storage device module 10. The current sensor 30 detects a current value I flowing in the electricity storage device module 10. The pyro-fuse 40 is connected in series to the electricity storage device module 10. The controller 50 causes the pyro-fuse 40 to activate. The controller 50 sets a voltage condition and a current condition. The voltage condition is predetermined based on the voltage value V detected by the voltage sensor 20. The current condition is predetermined based on the current value I detected by the current sensor 30. The controller 50 causes the pyro-fuse 40 to activate when both the voltage condition and the current condition are satisfied. In the electricity storage apparatus 100 as described above, the conditions for activating the pyro-fuse 40 are defined based on both the voltage condition and the current condition. This prevents the pyro-fuse 40 from being activated when, for example, the voltage value V and the current value I are incorrectly detected due to noise or the like. Therefore, it is possible to more accurately determine whether or not abnormality has occurred in the electricity storage device module 10. As a result, the risk of activation of the pyro-fuse 40 due to erroneous behavior is reduced. The timing of activation of the pyro-fuse 40 is properly controlled, so the risk of shutdown of the electricity storage device module 10 due to an erroneous operation is reduced. As a result, the electricity storage apparatus 100 achieves improved safety.

In the above-described embodiment, the voltage condition is set to be that, during discharging, “the voltage value V of the electricity storage device module 10 is lower than or equal to a predetermined threshold value Vth (the lower limit threshold value Vthl in this embodiment)”. This may detect an abnormality that can occur when the electricity storage device module 10 is overdischarged, and causes the pyro-fuse 40 to interrupt the conductive path. As a result, the electricity storage apparatus 100 may achieve improved safety.

In the above-described embodiment, the voltage condition is set to be that, during charging, “the voltage value V of the electricity storage device module 10 is higher than or equal to a predetermined threshold value Vth (the upper limit threshold value Vthu in this embodiment)”. This may detect an abnormality that can occur when the electricity storage device module 10 is overcharged, and causes the pyro-fuse 40 to interrupt the conductive path. As a result, the electricity storage apparatus 100 may achieve improved safety.

In the above-described embodiment, the current condition is set to be that “the current value I of the electricity storage device module 10 is higher than or equal to a predetermined threshold value Ith”. This may make it possible to detect an abnormality that may occur in the electricity storage apparatus 100 in both cases of charging and discharging. It should be noted that, when an overcurrent flows between the electricity storage device module 10 and the connected device 80, it is possible that overcharge occurs during charging and overdischarge occurs during discharging. In this embodiment, because the current condition is set to be that “the absolute value of the current value I of the electricity storage device module 10 is higher than or equal to a predetermined threshold value Ith”, abnormality is easily detected with high accuracy during charging and during discharging.

In the above-described embodiment, the voltage condition is defined based on the voltage V of one of the plurality of electricity storage devices 10a. This may serve to cut off the pyro-fuse 40 quickly even when abnormality occurs in one of the electricity storage devices 10a that are contained in the electricity storage device module 10. This may improve the safety of the electricity storage apparatus 100.

The voltage condition and the current condition that are set in the controller 50 for activating the pyro-fuse 40 are not limited to those described above. The voltage condition and the current condition may additionally include other conditions or may be changed to other conditions.

The voltage condition may be set to be that “the voltage value V is outside the detection range”. The phrase “outside the detection range” may mean, for example, the case in which the voltage value exceeds the detectable upper limit value in at least one of the voltage sensor 20 and the controller 50. The detectable upper limit value may depend on the device characteristics of the voltage sensor 20 and the controller 50 that are used. The detectable upper limit value of the voltage condition may be a higher value than the upper limit threshold value Vthu mentioned above. Employing such a voltage condition allows the pyro-fuse 40 to activate appropriately even in such cases that the voltage value V is not measured properly due to the occurrence of abnormality.

The current condition may be set to be that “the current value I is outside the detectable range”. The phrase “outside the detectable range” may mean, for example, the case in which the current value exceeds the detectable upper limit value in at least one of the current sensor 30 and the controller 50. The detectable upper limit value may depend on the device characteristics of the current sensor 30 and the controller 50 that are used. The detectable upper limit value of the current condition may be a higher value than the threshold value Ith mentioned above. Employing such a current condition allows the pyro-fuse 40 to activate appropriately even in such cases that the current value I is not measured properly due to the occurrence of abnormality.

The voltage sensor 20 is not limited to the configuration that detects the voltage value V and transmits it as a signal to the controller 50. The voltage sensor 20 may be able to detect at least one event of overcharge and overdischarge of the electricity storage device module 10 or the electricity storage devices 10a. For example, the voltage sensor 20 may be configured to be able to detect the voltage value V. The voltage sensor 20 may be provided with a threshold value at which overcharge or overdischarge occurs (for example, the threshold value Vth mentioned above). Thus, the voltage sensor 20 may be configured to be able to detect an overcharge or overdischarge event that is detected by the controller 50 in the above-described embodiment. Herein, the voltage sensor 20 may be configured to be able to notify the controller 50 of detection of at least one of the above-mentioned events when the voltage sensor 20 detects the just-mentioned event. The voltage condition may be set to be that “at least one event of overcharge and overdischarge has been notified from the voltage sensor 20”. Because overcurrent and overcharge are detected also by the voltage sensor 20, the accuracy of abnormality detection may be increased.

Similarly, the current sensor 30 is not limited to the configuration that detects the current value I and transmits it as a signal to the controller 50. The current sensor 30 may be able to detect an overcurrent of the electricity storage device module 10. For example, the current sensor 30 may be configured to be able to detect the current value I. The current sensor 30 may be provided with a threshold value at which overcurrent occurs (for example, the threshold value Ith mentioned above). Thus, the current sensor 30 may be configured to be able to detect an overcurrent event that is detected by the controller 50 in the above-described embodiment. Herein, the current sensor 30 may be configured to be able to notify the controller 50 that the current sensor 30 has detected an overcurrent when it has detected an overcurrent. The current condition may be set to be that “detection of an overcurrent has been notified from the current sensor 30”. Because an overcurrent is detected also by the current sensor 30, the accuracy of abnormality detection may be increased.

Moreover, the controller 50 may be provided with a voltage condition that “communication from the voltage sensor 20 to the controller 50 has been cut off”. Likewise, the controller 50 may be provided with a current condition that “communication from the current sensor 30 to the controller 50 has been cut off”. These events may be determined when the controller 50 does not receive signals from the sensors (the voltage sensor 20 and the current sensor 30) although the electricity storage apparatus 100 has already been started up. Setting such conditions makes it easier to detect failures that may occur in the electricity storage apparatus 100.

As described above, the electricity storage apparatus 100 may be provided with a plurality of voltage conditions and a plurality of current conditions. Setting a plurality of conditions allows the pyro-fuse 40 to be activated more easily in response to various failures that may occur in the electricity storage apparatus 100. As a result, the electricity storage apparatus 100 may achieve improved safety.

Various embodiments of the technology according to the present disclosure have been described hereinabove. Unless specifically stated otherwise, the embodiments described herein do not limit the scope of the present disclosure. It should be noted that various other modifications and alterations may be possible in the embodiments of the technology disclosed herein. In addition, the features, structures, or steps described herein may be omitted as appropriate, or may be combined in any suitable combinations, unless specifically stated otherwise. In addition, the present description includes the disclosure as set forth in the following items.

### Item 1:

An electricity storage apparatus including:
an electricity storage device module including a plurality of electricity storage devices;
a voltage sensor detecting a voltage value of the electricity storage device module;
a current sensor detecting a current value flowing in the electricity storage device module;
a pyro-fuse connected in series to the electricity storage device module; and
a controller causing the pyro-fuse to activate, wherein:
the controller sets a voltage condition and a current condition,
   the voltage condition being predetermined based on the voltage value detected by the voltage sensor, and
   the current condition being predetermined based on the current value detected by the current sensor; and
the pyro-fuse is activated when both the voltage condition and the current condition are satisfied.

### Item 2:

The electricity storage apparatus according to item 1, wherein the voltage condition is that the voltage value of the electricity storage device module is lower than or equal to a predetermined threshold value.

### Item 3:

The electricity storage apparatus according to item 1, wherein the voltage condition is that the voltage value of the electricity storage device module is higher than or equal to a predetermined threshold value.

### Item 4:

The electricity storage apparatus according to any one of items 1 to 3, wherein the current condition is that the current value of the electricity storage device module is higher than or equal to a predetermined threshold value.

### Item 5:

The electricity storage apparatus according to any one of items 1 to 4, wherein the voltage condition is defined based on the voltage value of one of the plurality of electricity storage devices.

### Item 6:

The electricity storage apparatus according to any one of items 1 to 5, wherein the voltage condition is that the voltage value is outside a detection range.

### Item 7:

The electricity storage apparatus according to any one of items 1 to 6, wherein the current condition is that the current value is outside a detection range.

### Item 8:

The electricity storage apparatus according to any one of items 1 to 7, wherein:
the voltage sensor is configured to be able to detect at least one event of overcharge and overdischarge, and to notify the controller of detection of the at least one event when detecting the at least one event; and
the voltage condition is that the detection of the at least one event has been notified from the voltage sensor.

### Item 9:

The electricity storage apparatus according to any one of items 1 to 8, wherein:
the current sensor is configured to be able to notify, when detecting an overcurrent, the controller of detection of the overcurrent; and
the current condition is that the detection of the overcurrent has been notified from the current sensor.

### Item 10:

A method of interrupting electric current flowing in an electricity storage device module including a plurality of electricity storage devices, the method including the steps of:
detecting a voltage value of the electricity storage device module;
detecting a current value flowing in the electricity storage device module; and
activating a pyro-fuse when a predetermined condition is satisfied, wherein:
the pyro-fuse is connected in series to the electricity storage device module;
the predetermined condition includes:
   a voltage condition defined based on the voltage value; and
   a current condition defined based on the current value; and
the pyro-fuse is activated when both the voltage condition and the current condition are satisfied.

What is claimed is:

1. An electricity storage apparatus comprising:
an electricity storage device module including a plurality of electricity storage devices;
a voltage sensor detecting a voltage value of the electricity storage device module;
a current sensor detecting a current value flowing in the electricity storage device module;
a pyro-fuse connected in series to the electricity storage device module; and
a controller causing the pyro-fuse to activate, wherein:
the controller sets a voltage condition and a current condition,
the voltage condition being predetermined based on the voltage value detected by the voltage sensor, and
the current condition being predetermined based on the current value detected by the current sensor; and
the pyro-fuse is activated when both the voltage condition and the current condition are satisfied.

2. The electricity storage apparatus according to claim 1, wherein the voltage condition is that the voltage value of the electricity storage device module is lower than or equal to a predetermined threshold value.

3. The electricity storage apparatus according to claim 1, wherein the voltage condition is that the voltage value of the electricity storage device module is higher than or equal to a predetermined threshold value.

4. The electricity storage apparatus according to claim 1, wherein the current condition is that the current value of the electricity storage device module is higher than or equal to a predetermined threshold value.

5. The electricity storage apparatus according to claim 1, wherein the voltage condition is defined based on the voltage value of one of the plurality of electricity storage devices.

6. The electricity storage apparatus according to claim 1, wherein the voltage condition is that the voltage value is outside a detection range.

7. The electricity storage apparatus according to claim 1, wherein the current condition is that the current value is outside a detection range.

8. The electricity storage apparatus according to claim 1, wherein:
the voltage sensor is configured to be able to detect at least one event of overcharge and overdischarge, and to notify the controller of detection of the at least one event when detecting the at least one event; and
the voltage condition is that the detection of the at least one event has been notified from the voltage sensor.

9. The electricity storage apparatus according to claim 1, wherein:
the current sensor is configured to be able to notify, when detecting an overcurrent, the controller of detection of the overcurrent; and
the current condition is that the detection of the overcurrent has been notified from the current sensor.

10. A method of interrupting electric current flowing in an electricity storage device module including a plurality of electricity storage devices, the method comprising the steps of:
detecting a voltage value of the electricity storage device module;
detecting a current value flowing in the electricity storage device module; and
activating a pyro-fuse when a predetermined condition is satisfied, wherein:
the pyro-fuse is connected in series to the electricity storage device module;
the predetermined condition includes:
a voltage condition defined based on the voltage value; and
a current condition defined based on the current value; and
the pyro-fuse is activated when both the voltage condition and the current condition are satisfied.
